(19) United States
(12) Patent Application Publication
(10) Pub. No.: US 2023/0417914 A1
(43) Pub. Date: Dec. 28, 2023

(54) METHOD FOR DETERMINING A RELATIVE POSITION OF A FIRST PART OF A MOBILE PLATFORM WITH RESPECT TO A SECOND PART OF THE MOBILE PLATFORM

(71) Applicant: Robert Bosch GmbH, Stuttgart (DE)

(72) Inventors: Florent Chretien, Stuttgart (DE); Tim Raudies, Sachsenheim (DE)

(21) Appl. No.: 18/247,855

(22) PCT Filed: Sep. 27, 2021
(86) PCT No.: PCT/EP2021/076454

§ 371 Date: Apr. 4, 2023

(30) Foreign Application Priority Data
Oct. 19, 2020 (DE) 10 2020 213 131.7

(51) Int. Cl. G01S 17/875; G01S 17/931; G01S 7/497; G01S 17/86

(52) U.S. Cl. CPC G01S 17/875; G01S 17/931; G01S 7/4972; G01S 17/86

(57) ABSTRACT

A method for determining a relative position of a first part of a mobile platform with respect to a second part of the mobile platform. The method includes the following steps: providing at least one first position point of an object in an environment of the mobile platform relative to the first part of the mobile platform; providing at least one second position point of the object in the environment of the mobile platform relative to the second part of the mobile platform; determining the relative position of the first part of the mobile platform with respect to the second part of the mobile platform by comparing the relative position of the at least one first position point with the relative position of the at least one second position point.

### BACKGROUND INFORMATION

For highly automated driving (HAD), appropriately designed vehicles typically have omnidirectional sensors, such as radar sensors, LiDAR sensors, video systems, ultrasonic systems, etc., which observe the environment. These signals and objects, which are generated or identified, respectively, by these different systems, must be fused to depict an environment of the vehicles.

If these vehicles are trucks, a feature thereof is that the cabs of the trucks are spring-mounted for comfort, so that vibrations and shocks are not transmitted from the chassis of the truck to the truck cab and therefore to the driver.

If it is then technically necessary to mount sensors both on the chassis and on the cab, the movements of the cab must be taken into account in order to fuse the signals correctly with one another. These movements could hitherto only be measured with difficulty, if at all.

For testing purposes, movements of the cab may be determined with the aid of two GPS (global positioning system)-supported gyro measuring systems, of which one is mechanically coupled to the chassis and the other is mechanically coupled to the cab. However, like the cab, a GPS antenna which is mounted on the cab roof likewise changes its relative position with respect to the chassis. As a result, the corresponding measured values may be distorted.

As a further option, at least one pitch angle may be determined by a camera coupled to the cab using images generated by the camera to obtain adjustment values for sensor fusion.

### SUMMARY

According to aspects of the present invention, a method for determining a relative position of a first part of a mobile platform with respect to a second part of the mobile platform, a method for determining at least one adjustment value, a method for calibrating a first sensor, an evaluation system, a detection system, a computer program and a machine-readable storage medium are provided. Advantageous configurations of the present invention are disclosed herein.

In this entire description of the present invention, the sequence of method steps is presented such that the method is easily understandable. However, a person skilled in the art will recognize that many of the method steps may also proceed in a different sequence and lead to the same result. In this context, the sequence of the method steps may be altered appropriately and is therefore also disclosed.

According to one aspect of the present invention, a method for determining a relative position of a first part of a mobile platform with respect to a second part of the mobile platform is provided. According to an example embodiment of the present invention, the method includes the following steps:

In one step, at least one first position point of an object in an environment of the mobile platform relative to the first part of the mobile platform is provided. In a further step, at least one second position point of the object in the environment of the mobile platform relative to the second part of the mobile platform is provided. In a further step, the relative position of the first part of the mobile platform with respect to the second part of the mobile platform is determined by comparing the relative position of the at least one first position point with the relative position of the at least one second position point.

The first position point and/or the second position point of the object in the environment may be determined using a sensor system which detects or represents the environment, for example an optical camera and/or a video system and/or a radar system and/or a LiDAR system and/or a laser system and/or an ultrasonic system. Using these sensor systems of different modality, the mobile platform may be designed to observe the mobile platform and/or to identify objects in the environment of the mobile platform.

The first position point and/or the second position point may relate to a different point of an object; alternatively or additionally, the first position point and/or the second position point may relate to an identical point of an object, which is determined by different sensor systems.

For example, using the method, a movement of a cab as a first part of a mobile platform with respect to a chassis as a second part of the mobile platform may therefore be determined via deviations in respectively determined position points of objects using a first and a second sensor system.

The movement here represents a change in the relative position of a first part of the mobile platform with respect to the second part of the mobile platform. Based on the change in the relative position, it is possible to determine adjustment values for fusing sensor systems for environment detection which are mechanically coupled, in particular, to different parts of the mobile platform.

In the method according to the present invention provided here, the cab movement is therefore not determined by a GPS-supported gyro system whereof the GPS antenna is typically likewise installed on the movable cab and is therefore inherently error-prone.

The adjustment values of the method provided according to the present invention may therefore also be used for adjustment for the antenna movement of the GPS-supported gyro measuring system, since accurate determination of the position of a mobile platform, for example a vehicle, is important for highly automated driving (HAD) in order to ascertain an accurate position of the mobile platform. The robustness of the highly automated driving is therefore increased by the proposed method.

The method according to the present invention may be carried out, for example, using two sensors, of which one is fixed on the chassis and the other is fixed on the cab of a truck in order to determine a first and a second position point via the two sensor systems and hence to determine the relative position of the first part of the mobile platform with respect to the second part of the mobile platform. According to some aspects of the present invention, the method can be carried out using a plurality of sensor systems of different modality; in particular, according to some provided aspects of the present invention, the method according to the present invention may be carried out using one LiDAR sensor or two LiDAR sensors.

Alternatively or additionally, the method of the present invention may be carried out using at least one camera system and/or at least one ultrasonic system and/or at least one radar system.

If the two sensor systems are vertically and/or horizontally distanced from one another, the resolution for the identifying and locating objects using fused sensor signals may be increased.

According to one aspect of the present invention, it is provided that the object is a ground surface in the environment of the mobile platform; and the at least one first position point on the ground surface is determined by a first sensor system; and the first sensor system is directly coupled to the first part of the mobile platform; and the at least one second position point of the object is a stored reference value.

Alternatively or additionally to this aspect of the present invention, the at least one first position point on the ground surface may be determined by a camera system and/or an ultrasonic system and/or a radar system.

In particular, using the respective sensor system, the respective position point may be determined at different points in time in order to compare the relative position of the at least one first position point to the relative position of the at least one second position point.

In the case of a camera system, for example, this may take place via an optical flow, which is captured by the respective camera system. Moreover, the method of the present invention may be improved by stereo camera systems.

With an ultrasonic system, the method of the present invention, using a two-row arrangement of ultrasonic generators, may determine the first and/or second position point by determining a distance at a fixed angle with respect to the respective part of the mobile platform.

A radar system can be used to carry out distance determination at a fixed angle with respect to the respective part of the mobile platform in order to determine the first and/or second position point.

According to one aspect of the present invention, it is provided that the at least one second position point on the ground surface in the environment of the mobile platform is determined by a second sensor system; and the second sensor system is directly coupled to the second part of the mobile platform.

The accuracy of the method for determining a relative position of a first part of the mobile platform with respect to a second part of the mobile platform may be improved as a result of the second sensor system.

For example, according to an example embodiment of the present invention, two LiDAR systems may be installed at different heights on the front corners of a truck, a first on a movable cab and a second on a chassis of the truck. The respective reflected sensors signals detect the object: ground surface differently if the first LiDAR system assumes a changed relative position with respect to the second LiDAR system, which corresponds to the changed relative position of the parts of the mobile platform since the two LiDAR systems are mechanically coupled to different parts of the truck.

For example, a pitching of the cab relative to the chassis results in differently determined distances from the ground surface for the respective LiDAR systems, which may be determined, for example, by changes in the distances of reflection circles of the respective LiDAR systems on the ground surface.

For example, a change in the height of the cab relative to the chassis results in a change in the distance of all reflection circles of the respective LiDAR systems relative to the truck. In particular, an initial state of at least some of the reflection circles on the ground surface may be determined and stored at the start of a driving cycle of the truck. During the journey, the adjustment values minus such stored base values may then be interpreted as cab movement. The movement of the cab due to uneven terrain may be advantageously discerned via the second LiDAR system, which is mechanically coupled to the chassis, and the sensor values thereof according to a reference measurement.

In the method according to an example embodiment of the present invention, sensitive and accurate determination of the position points on the ground surface may be achieved by determining the reflection points at the greatest possible distance from the respective sensor systems so long as they still relate to the ground surface. This is because the distances to be determined are consequently increased, thus improving the accuracy.

With the method of the present invention, it is therefore also advantageously possible to discern whether the relative position of the first part of the mobile platform with respect to the second part of the mobile platform should be attributed to a pitching movement of the cab relative to the chassis or to a vertical displacement of the cab relative to the chassis.

According to one aspect of the present invention, it is provided that the respective sensor system is a LiDAR system; and the respective LiDAR system determines two position points on the ground in each case, and a distance of the two position points in each case is determined by determining a distance of at least two ground reflections on the ground which are each generated by two LiDAR beams emitted at different angles by the respective LiDAR system. The accuracy of the method may thus be improved.

According to one aspect of the present invention, it is provided that the respective sensor system is a LiDAR system; and the respective LiDAR system determines a plurality of position points on the ground in each case by determining a respective distance of two ground reflections on the ground in each case, wherein the plurality of ground reflections are each generated by a number of LiDAR beams emitted at different angles by the respective LiDAR system. This may further increase the accuracy of the method.

Moreover, the accuracy and the sensitivity of the method may be increased in that the position points are determined opposite one another in respective pairs on the reflection circle, i.e., with a 180° spatial rotation. Therefore, in the event of a pitching movement in this axis, distance variations of the respective reflection circles through 180° should therefore be established.

According to one aspect of the present invention, it is provided that the plurality of ground reflections are at an angle of 180° with respect to the respective LiDAR system in respective pairs.

According to one aspect of the present invention, it is provided that the at least one first position point of the object in the environment of the mobile platform is provided by a first sensor system; and the first sensor system is directly coupled to the first part of the mobile platform; and the at least one second position point of the object in the environment of the mobile platform is provided by a second sensor system; and the second sensor system is directly coupled to the second part of the mobile platform.

According to this aspect of the method of the present invention, the first sensor system may have a different modality to the second sensor system.

By determining the first position point using a first sensor system and the second position point using the second sensor system, it is achieved that the first position point and/or the second position point may relate to an identical point of an object in order to determine the relative position of a first part of the mobile platform with respect to the second part of the mobile platform.

In particular, the first and/or second object may be a road marking and/or another characteristic object at ground level.

According to one aspect of the present invention, it is provided that the object relates to a raised object above the ground surface in the environment and the relative position of the first part of the mobile platform with respect to the second part of the mobile platform is determined by comparing the at least one first position point of the raised object to the at least one second position point of the raised object.

A raised object is easy to identify and a position point can be determined with greater accuracy on a raised object.

In particular, the first sensor system and the second sensor system may each be a sensor system which is designed to determine a distance to a position point of an object.

In other words, movements of the cab, i.e., relative changes in the position of the cab with respect to the chassis, may be determined by the two LiDAR systems via the position of the position points, for example ascertained distances from the object in each case.

This aspect of the present method may be carried out using a plurality of sensor systems of different modality so long as the sensor systems may identify and determine position points on objects.

At the start of a driving cycle, a distance from one or more objects may be measured and stored as a base adjustment for calibrating the two sensor systems with respect to one another. Changes in the relative position of the respective sensor systems which are subsequently determined during the journey may then be attributed to a movement of the cab.

Differences in the determined position points, for example distances, may be advantageously used for fusing sensor signals which are generated by different types of sensor system.

According to one aspect of the present invention, it is provided that the respective sensor system comprises a LiDAR system and/or a camera sensor and/or a radar system and/or an ultrasonic system.

According to an example embodiment of the present invention, a method for determining at least one adjustment value for sensor fusion is provided, the at least one adjustment value being determined via a relative position of a first part of a mobile platform with respect to a second part of the mobile platform.

Such an adjustment value advantageously enables the fusion of sensor data which is generated in particular by sensors which are mechanically coupled to different parts of the mobile platform.

A method for calibrating a first sensor with a second sensor is provided according to an example embodiment of the present invention, the first sensor being directly coupled to a first part of the mobile platform; and the second sensor being directly coupled to the second part of the mobile platform and the calibration being determined according to one of the above-described methods via a relative position of the first part of the mobile platform with respect to the second part of the mobile platform.

According to an example embodiment of the present invention, an evaluation system for determining a relative position of a first part of a mobile platform with respect to a second part of the mobile platform is provided, which is designed to execute one of the above-described methods. Using such an evaluation system, it is possible to easily integrate at least one of the above-described methods into different mobile platforms.

According to an example embodiment of the present invention, a detection system for determining a relative position of a first part of a mobile platform with respect to a second part of the mobile platform is provided, which has a first sensor system and a second sensor system and an evaluation system, as described above, in order to determine a relative position of a first part of a mobile platform with respect to a second part of the mobile platform. Such a detection system enables the method of the present invention to be easily integrated into different mobile platforms and optimized in terms of accuracy by tailoring the sensor systems to the method.

According to one aspect of the present invention, a computer program is specified, which comprises commands which, when the computer program is executed by a computer, prompt this latter to execute one of the above-described methods of the present invention. Such a computer program enables the use of the described method in different systems.

According to an example embodiment of the present invention, a machine-readable storage medium is specified, on which the above-described computer program is stored. Such a machine-readable storage medium enables the above-described computer program to be transportable.

A mobile platform may be understood to mean an at least partly automated system, which is mobile, and/or a driver assistance system. One example may be an at least partly automated vehicle or a vehicle comprising a driver assistance system. That is to say, in this connection, an at least partly automated system includes a mobile platform in connection with at least partly automated functionality, but a mobile platform also includes vehicles and other mobile machines including driver assistance systems. Further examples of mobile platforms may be driver assistance systems having multiple sensors or mobile multi-sensor robots.

### BRIEF DESCRIPTION OF THE DRAWINGS

Exemplary embodiments of the present invention are illustrated with reference to FIGS. 1A to 3 and explained in more detail below.

FIG. 1A shows a front view of a truck having a cab and chassis with exemplary positions of two LiDAR systems.

FIG. 1B shows a side view of a truck having a cab and chassis with exemplary positions of two LiDAR systems.

FIG. 2 shows a plan view of a truck with reflection points of a LiDAR system which are arranged in a ring formation on a ground surface.

FIG. 3 shows a plan view of a truck with reflection points of two LiDAR systems which are arranged in a ring formation on a ground surface.

### DETAILED DESCRIPTION OF EXAMPLE EMBODIMENTS

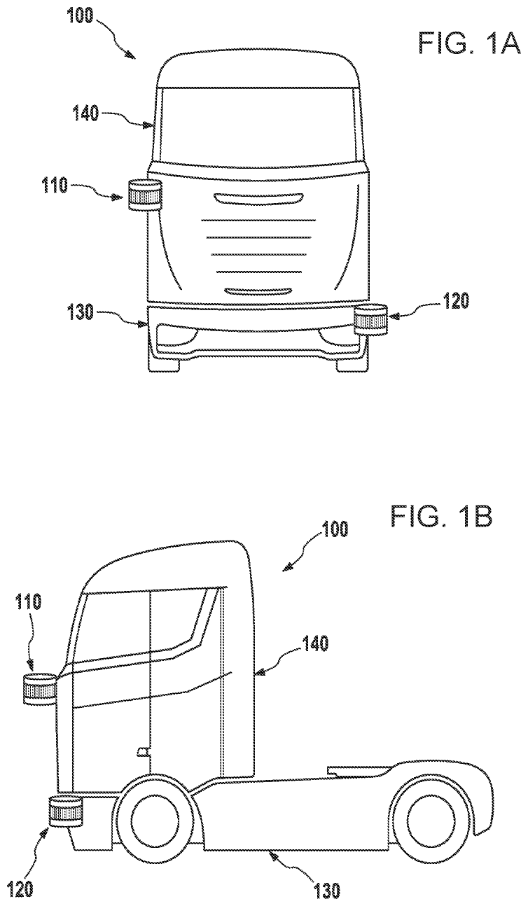

FIG. 1A shows a schematic sketch of a front view of a truck 100 having a chassis 130 and a cab 140, a first LiDAR system 110 being mechanically coupled to the cab 140 and a second LiDAR system 120 being mechanically coupled to the chassis 130.

FIG. 1B shows a schematic side view of a truck 100 having the chassis 130 and the cab 140, the first LiDAR system 110 being mechanically coupled to the cab 140 and the second LiDAR system 120 being mechanically coupled to the chassis 130.

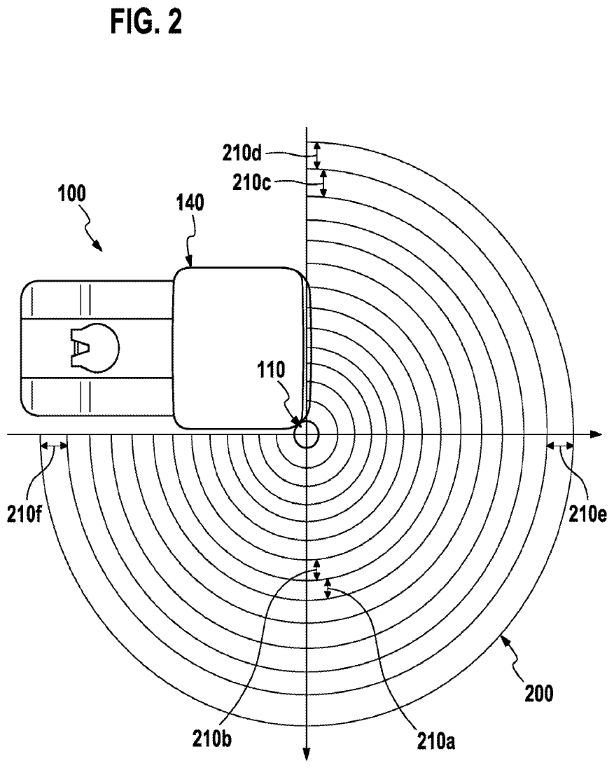

FIG. 2 shows a plan view of the truck 100, schematically depicting reflection points 200 arranged in a ring formation, which are produced by the first LiDAR system 110 by directing the laser beams of the LiDAR system 110 at a ground surface in the environment of the truck 100. The distance arrows 210a to f show possible distances of the reflection points 200 arranged in a ring formation depending on a relative position of the cab 140 with respect to level ground, the cab being coupled to the first LiDAR system 110. If the cab 140 is tilted with respect to the ground, for example, there is a change in the distances 210a to f between the different reflection points of the laser beams of the LiDAR system 110 which are emitted at different angles, which distances are determined by the LiDAR system 110. Therefore, by comparing the positions—provided by the LiDAR system 110—of a first and second position point (whereof the relative positions are denoted by the distance arrows 210a to 210f, for example), the relative position of the first part of the mobile platform with respect to the second part of the mobile platform may be determined, for example, if the second platform 130 may be assumed to be sufficiently parallel to the ground surface and/or the relative position of the position points is determined using a reference measurement and/or the at least second position point of the object is a stored reference value.

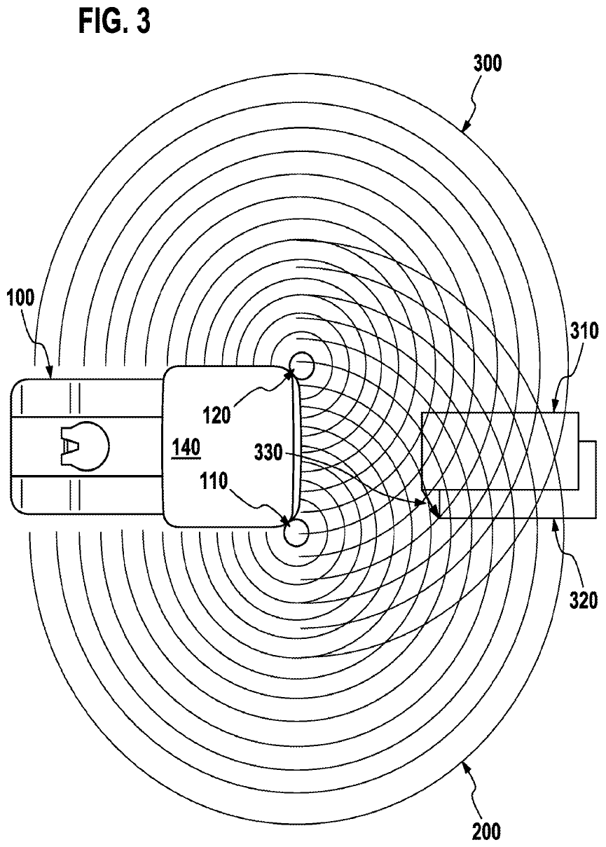

FIG. 3 shows a plan view of the truck 100, schematically depicting reflection points 200 arranged in a ring formation, which are produced on a ground surface in the environment of the truck 100 by the first LiDAR system 110, and reflection points 300 arranged in a ring formation, which are produced on the ground surface in the environment of the truck 100 by the second LiDAR system 120.

The relative position of the first part of the mobile platform with respect to the second part of the mobile platform here may be determined in that, via the first LiDAR system 110, which is mechanically coupled to the cab 140 of the truck 100, an object 310, 320 is identified, a first position point of the object 310, 320 is spatially determined and this is compared to a second position point of the object 310, 320—the position point of the object 310, 320 identified by the second LiDAR system 120 which is provided by the second LiDAR system. The object 310 here is the same object as the object 320, although they are detected in virtually different locations by different sensor systems. Since, for the two LiDAR systems 110, 120, the object has a different position in space as seen relatively from the respective LiDAR system, for example due to a relative position change of the first part of the mobile platform with respect to the second part of the mobile platform, it is possible, from the comparison, to determine the relative position of the first part of the mobile platform with respect to the second part of the mobile platform from a difference 330 in the position of the respective position points.

1-15. (canceled)

16. A method for determining a relative position of a first part of a mobile platform with respect to a second part of the mobile platform, comprising the following steps:
providing at least one first position point of an object in an environment of the mobile platform relative to the first part of the mobile platform;
providing at least one second position point of the object in the environment of the mobile platform relative to the second part of the mobile platform; and
determining the relative position of the first part of the mobile platform with respect to the second part of the mobile platform by comparing the relative position of the at least one first position point with the relative position of the at least one second position point.

17. The method as recited in claim 16, wherein the object is a ground surface in the environment of the mobile platform, and the at least one first position point on the ground surface is determined by a first sensor system, and the first sensor system is directly coupled to the first part of the mobile platform, and the at least one second position point of the object is a stored reference value.

18. The method as recited in claim 17, wherein the at least one second position point on the ground surface in the environment of the mobile platform is determined by a second sensor system, and the second sensor system is directly coupled to the second part of the mobile platform.

19. The method as recited in claim 18, wherein the first and second sensor systems are respective LiDAR systems; and each of the respective LiDAR systems determines two position points on the ground, and a distance of the two position points in each case is determined by determining a distance of at least two ground reflections on the ground which are each generated by two LiDAR beams emitted at different angles by the respective LiDAR system.

20. The method as recited in claim 18, wherein the first and second sensor systems are respective LiDAR systems, and each of the respective LiDAR systems determines a plurality of position points on the ground by determining a respective distance of two ground reflections on the ground, wherein the ground reflections are generated by a number of LiDAR beams emitted at different angles by the respective LiDAR systems.

21. The method as recited in claim 20, wherein the ground reflections are at an angle of 180° with respect to the respective LiDAR systems in respective pairs.

22. The method as recited in claim 16, wherein:
the at least one first position point of the object in the environment of the mobile platform is provided by a first sensor system, and the first sensor system is directly coupled to the first part of the mobile platform; and
the at least one second position point of the object in the environment of the mobile platform is provided by a second sensor system, and the second sensor system is directly coupled the second part of the mobile platform.

23. The method as recited in claim 22, wherein the object is a raised object above a ground surface in the environment and the relative position of the first part of the mobile platform with respect to the second part of the mobile platform is determined by comparing the at least one first position point of the raised object to the at least one second position point of the raised object.

24. The method as recited in claim 17, wherein each of the first and second sensor systems includes a LiDAR system and/or a camera sensor and/or a radar sensor and/or an ultrasonic system.

25. The method as recited in claim 16, further comprising:
determining at least one adjustment value for sensor fusion using the determined relative position of a first part of a mobile platform with respect to a second part of the mobile platform.

26. The method as recited in claim 16, further comprising:
determining a calibration of the a first sensor system with a second sensor system using the determined relative position of the first part of the mobile platform with respect to the second part of the mobile platform.

27. An evaluation system for determining a relative position of a first part of a mobile platform with respect to a second part of the mobile platform, the evaluation system being configured to:
provide at least one first position point of an object in an environment of the mobile platform relative to the first part of the mobile platform;
provide at least one second position point of the object in the environment of the mobile platform relative to the second part of the mobile platform; and
determine the relative position of the first part of the mobile platform with respect to the second part of the mobile platform by comparing the relative position of the at least one first position point with the relative position of the at least one second position point.

28. A detection system for determining a relative position of a first part of a mobile platform with respect to a second part of the mobile platform, comprising:
a first sensor system;
a second sensor system; and
an evaluation system configured to:
provide at least one first position point of an object in an environment of the mobile platform relative to the first part of the mobile platform,
provide at least one second position point of the object in the environment of the mobile platform relative to the second part of the mobile platform, and
determine the relative position of the first part of the mobile platform with respect to the second part of the mobile platform by comparing the relative position of the at least one first position point with the relative position of the at least one second position point.

29. A non-transitory machine-readable storage medium, on which is stored a computer program for determining a relative position of a first part of a mobile platform with respect to a second part of the mobile platform, the computer program, when executed by a computer, causing the computer to perform the following steps:
providing at least one first position point of an object in an environment of the mobile platform relative to the first part of the mobile platform;
providing at least one second position point of the object in the environment of the mobile platform relative to the second part of the mobile platform; and
determining the relative position of the first part of the mobile platform with respect to the second part of the mobile platform by comparing the relative position of the at least one first position point with the relative position of the at least one second position point.
